(19) United States
(12) Patent Application Publication
(10) Pub. No.: US 2021/0349025 A1
(43) Pub. Date: Nov. 11, 2021

(54) OPTIMIZED OPTICAL SETUP TO MAXIMIZE FLUORESCENCE DETECTION IN SAMPLES

(71) Applicant: OZ Optics Ltd., Ottawa (CA)

(72) Inventors: Omur Sezerman, Ottawa (CA); Garland Best, Almonte (CA); Mamoun Wahbeh, Ottawa (CA); Danut Dascalu, Ottawa (CA)

(21) Appl. No.: 17/314,518

(22) Filed: May 7, 2021

(30) Foreign Application Priority Data
May 7, 2020 (CA) 3080089
May 27, 2020 (CA) 3081873

(51) Int. Cl. G01N 21/64

(52) U.S. Cl. CPC G01N 21/6452; G01N 2021/6471; G01N 2021/6482; G01N 21/6428

(57) ABSTRACT

An optical setup to detect fluorescence in samples is described, taking advantage of the geometry of sample vials to optimize both the excitation of fluorescence within said sample vials and the detection of fluorescence from the sample as it is emitted. Said optical geometry can be adapted for different sample containers and can be used in a variety of optical setup, both in single sample test systems as well as sample arrays.

### BACKGROUND OF THE INVENTION

The present invention relates to a fluorescence detection system, used to measure variation in the fluorescence properties of substances or products that are the outcome of chemical reactions. For example, cyclic DNA amplification reactions (such as polymerase chain reaction (PCR) or Loop-Mediated Isothermal Amplification (LAMP) reactions), carried out in the presence of intercalatory fluorescent pigment are used in the detection of pathogens such as viruses and bacteria, and are widely used in disease detection (such as detection of COVID-19), as well as assaying the health properties of food and of water supplies. As such many patents have been granted describing ways and means to illuminate samples with light of the desired wavelength to excite fluorescence as well as capture light from said samples. As examples, Kordunsky et al (U.S. Pat. No. 7,749,736B2) describes a detection system with source, detector, lenses and filters on top of a movable platform that transmits light down and back through the top of the sample. Lem at al (U.S. Pat. No. 7,466,908B1) describes an optical layout where the source optics are on one side of a sample vial, while the detection optics are on the opposite side of a vial. Finally, Mitoma (U.S. Pat. No. 6,144,448) describes using a fiber bundle in contact with the bottom of the vial.

The drawbacks to the above-mentioned geometries are that they do not take into consideration how the vial geometry itself impacts the propagation of the excitation light and the fluorescence signal. While Koudunsky's system has the advantage of dealing with flat surfaces as viewed from the top, it by necessity has the source and detection optics at a large distance from the sample, limiting the collection efficiency from the sample. Lem et al has the light striking the side of a conic vial, causing the light to refract out of the way of the path to the detection optics. It is known that the excitation source should not land on the detector. As a result in these systems the collected light reaching the detection device (such as a photodiode, CCD or photomultiplier) is quite weak, which can lead to fluorescence signals being undetected. This can generate false negative results during tests, allowing potentially dangerous cases to go undetected. Finally, Mitoma's fiber geometry requires the fiber to be in or near contact with the sample vial which in some scenarios is not desirable. For instance, the point of contact can become a site of heat generation or transfer, affecting temperature sensitive reactions.

### BRIEF SUMMARY OF THE INVENTION

To optimize the excitation of fluorescence in the sample and to further optimize collection of light from the sample, the sample vial itself can be treated as an optical element in the system. Optical elements are designed taking into account the radius of curvature and refractive index of the sample vial and the sample itself. This increases the acceptance angle (numerical aperture) of the coupling optical elements within the sample to deliver and capture more excitation and emission photons, respectively, which increases the apparatus efficiency and sensitivity. In turn this ensures optimum concentration and distribution of the excitation light within the sample as well as optimum collection of the emission light from the sample onto the detector. By maximizing these signals one can detect florescent signals in less time, and from smaller or more diluted samples, thus improving the sensitivity and reducing false negative results from the tests. As an alternative embodiment, the sample vial tip can be immersed in index matching fluid contained in a transparent vessel, thereby negating the refractive effects of the sample vial to reduce scattering and improve overall efficiency.

In one aspect of the present invention, there is provided a fluorescence detecting apparatus comprising: a sample container for holding a sample; a block for holding the sample container and varying a temperature of the sample; a light source directed to the sample; a detector to detect and measure fluorescent light emitted by the sample; and optical elements which are configured to account for the focusing and refraction effects of the sample container and sample on the fluorescent light.

In another aspect, there is provided a fluorescence detecting apparatus comprising: a sample container for holding a sample; a container holder for holding the sample container and varying a temperature of the sample, said container holder having transparent walls and containing an index matching fluid; a light source directed to the sample; a detector to detect and measure fluorescent light emitted by the sample; wherein said container holder and index matching fluid are configured to account for and counteract the focusing and refraction effects of the sample container and sample.

### BRIEF DESCRIPTION OF THE DRAWINGS

The invention will be further understood from the following description with reference to the attached drawings.

FIG. 1 is a drawing of the cross section of a typical sample tube used in PCR studies, containing the sample liquid.

FIGS. 2a and 2b show the effects of refraction on incoming and outgoing light from the tube.

FIG. 3 shows one possible embodiment of the invention utilizing conventional free space optics to focus light from a suitable source to the sample and to collect light from the sample to a detector.

FIG. 4 shows how the embodiment shown in FIG. 3 can be expanded to be used with a single or two dimensional array of sample vials.

FIGS. 5a and 5b show alternative embodiments utilizing a mirror to transmit excitation and emission signals through a common optical path.

FIG. 6 shows how the embodiment shown in FIGS. 5a and 5b can be expanded to be used with a single or two dimensional array of sample vials.

FIG. 7 shows another embodiment using optical fibers to transfer light from the source to the sample and from the sample to the detector.

FIG. 8 shows an alternative solution using index matching fluid to negate the refractive effects from the vial and its contents.

FIG. 9 shows ways to control and modulate the intensity of the source signal to enhance detection of the emission light at the detector.

### DETAILED DESCRIPTION OF PREFERRED EMBODIMENTS

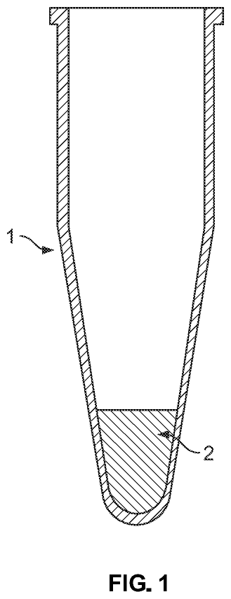

FIG. 1 shows the geometry of a PCR sample vial 1 used to contain samples for PCR testing, with the sample material 2 inside. These vials are typically made of propylene, although other materials can be used. The sample fluid 2 inside the vial is primarily water, which suspends the DNA, reagents, and fluorescent dyes. The rounded bottom of the vial is approximately spherical, with an outer radius R1 and inner radius R2. These vials are mass-produced, and their geometries are very repeatable from vial to vial. In addition, the volume of fluid injected into each vial is typically controlled using a pipette, so the minimum height h of the fluid inside the vial is reasonably well controlled. The refractive indices of polypropylene and water are 1.49 and 1.33 respectively.

As all these parameters are well determined, one can treat the rounded contour of the vial to be a spherical meniscus lens, and the liquid itself to act as a spherical lens. This lens property of the vial can therefore be optically modeled, and the surrounding optics can take advantage of this to improve the efficiency of the launch and collection optics. In example embodiments, lenses can be used to focus the light from the source to the center of the sample and to focus the light going to the detection system from the center of the sample.

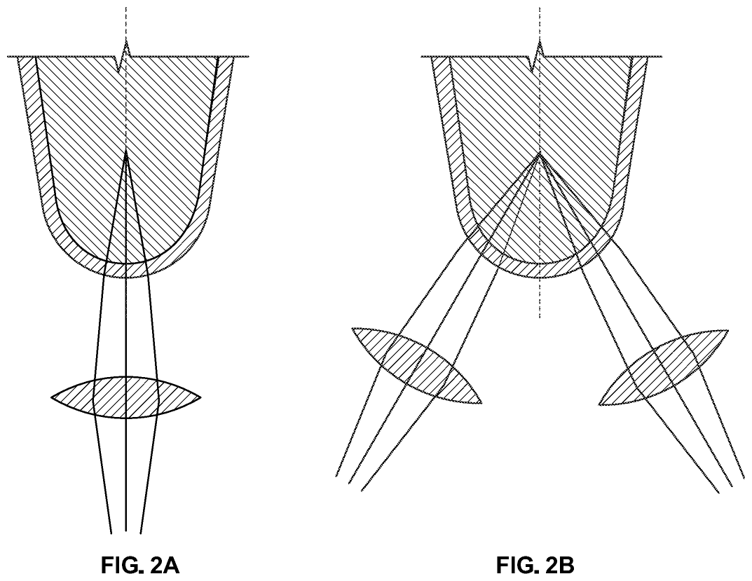

FIG. 2 show this concept in action. In FIG. 2a, light from a source is focused by a lens onto the bottom surface of the vial. As the light enters the vial it is refracted, further concentrating the light onto the sample. A lens can be designed so that the optical design as a whole is optimized to focus the light into the centroid of the sample fluid volume. Similarly, fluorescent light emitted by the sample will be refracted as it exits the vial, so optics can be optimized for light collection, see FIG. 2b. As the rounded bottom surface is almost hemispherical, one can have launch and collection light entering and exiting the vial at different angles, and as long as the light in question is still striking the rounded portion of the vial, the lensing aspect of the vial can be taken advantage of in the overall optical design.

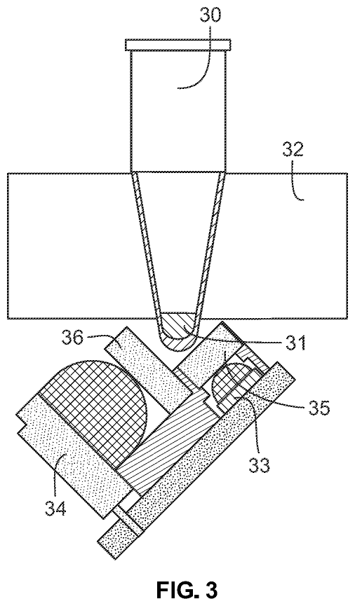

FIG. 3 shows one example embodiment of the present invention. A vial 30 with the sample 31 sits inside a block 32 with a hole designed to match the vial geometry. Heating and cooling elements are embedded in the block 32 to allow one to control the sample 31 temperature. This is because the chemical reactions used to replicate DNA and to induce fluorescence quite often need to take place at controlled temperatures. The block 32 therefore serves the dual purpose of both controlling the sample 31 temperature and precisely positioning the vial 30 relative to the optics.

A light emitting diode (LED) 33 of the desired excitation wavelength is designed with an integrated lens to focus the light onto the vial. The integrated lens is optically designed to account for the vial geometry. Similarly, a photodiode 34 with an integrated lens is designed to collect the maximum light from the vial, again taking into account the vial geometry in the optical design. In the embodiment shown, bandpass filters 35, 36 have been added in the optical paths. These filters 35, 36 are added to ensure that the photodiode 34 collects only the emission spectra of the sample, while blocking any of the excitation spectra from reaching the photodiode 34. In this way, the sensitivity of the apparatus is optimized. The photodiode 34 then generates an electrical signal, and by monitoring the signal strength seen by the photodiode 34 as the reaction occurs one can determine if the sample 31 is generating fluorescence, this indicating a positive result. The light source can be something other than an LED 33. For instance, it could be replaced with a laser diode or filtered tungsten lamp source. Similarly, the photodiode 34 could be replaced with either a CCD or CMOS photosensor, or with a compact spectrometer, which could measure the wavelength of the emission light as well as the intensity.

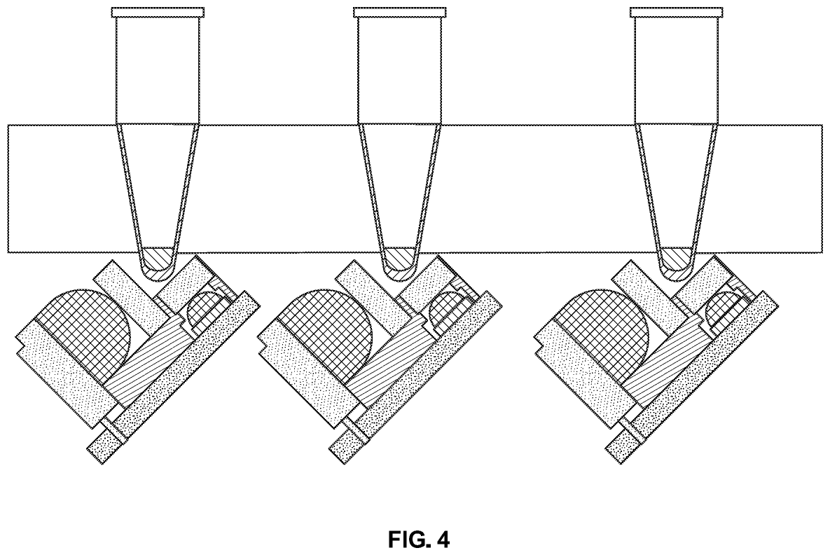

Because the entire optical arrangement can be made on a scale comparable to the sample vial, one can arrange multiples of the embodiment shown in either a linear or two dimensional array. This is illustrated in FIG. 4. In this manner, multiple samples can be tested simultaneously. This can allow one to test multiple samples en masse, thereby greatly increasing the number of samples tested in a given time.

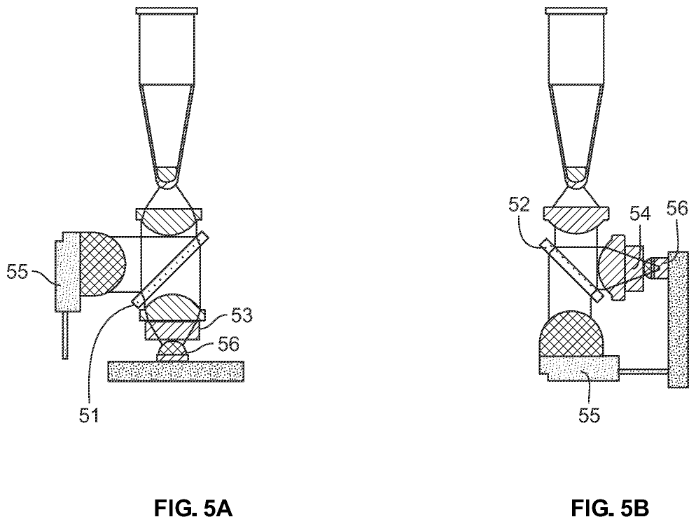

An alternative embodiment of the present invention utilizes a mirror to allow use of a single lens/optical path to both transmit the excitation light and collect the emission light. In one example embodiment, the mirror is a dichroic mirror, which reflects one range of wavelengths while transmitting either a longer or shorter range of wavelengths. This allows discrimination between the excitation and emission light in the optical signals. FIGS. 5a and 5b show two such example arrangements. FIG. 5a utilizes a short pass dichroic mirror 51, and FIG. 5b utilizes a long pass dichroic mirror 52. Bandpass filters 53, 54 can be added to further isolate the excitation light between the source 56 and the photodiode 55. Alternatively, one can use a partial reflecting mirror instead of a dichroic mirror, but at a cost to the overall efficiency and sensitivity. By using a single lens one can use larger optics with higher collections angles, as one has more physical room to work in immediately near the sample. As with the examples illustrated in FIG. 3, the lenses used to focus and collect the light are optimized with the geometry of the vial tip in mind, to maximize the sensitivity of the apparatus.

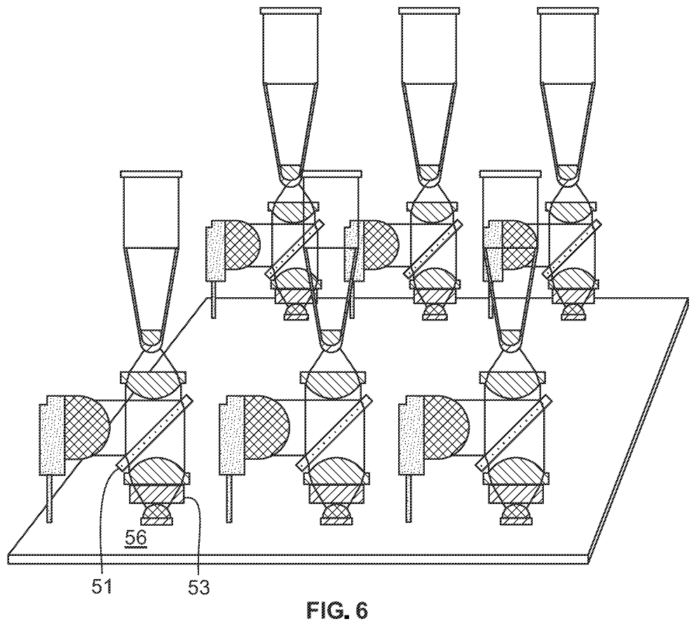

Again, such configurations can be laid out in a linear or two dimensional array to test multiple samples simultaneously. This is illustrated in FIG. 6.

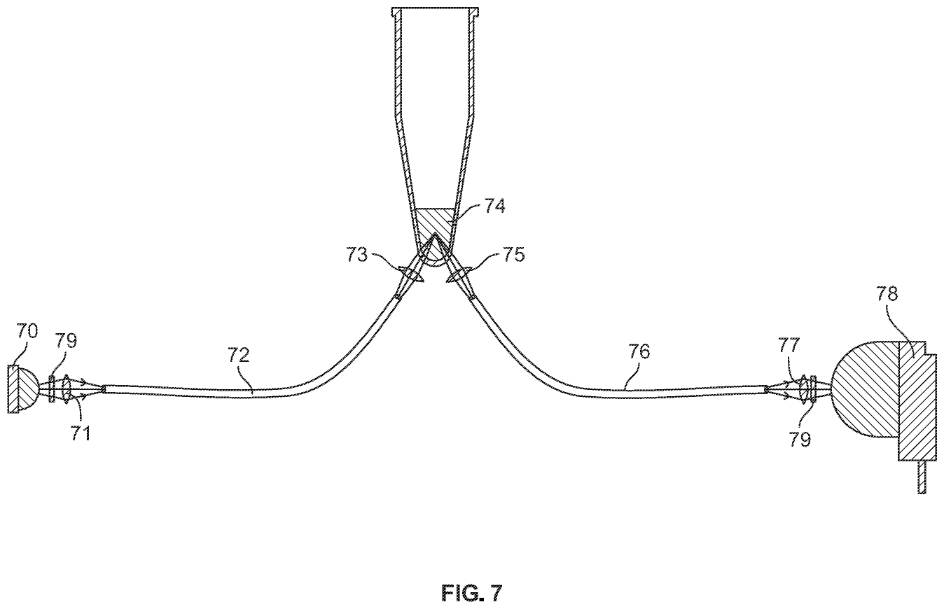

Another example embodiment of the invention makes use of optical fibers to transfer light to and from the sample. This concept is shown in FIG. 7. Excitation light from the source 70 is coupled by a lens 71 into an optical fiber 72 and when the light emerges from the other end of the fiber it is focused by a second lens 73 onto the sample 74. Similarly, the emission light from the sample is collected by a collecting lens 75 into a second fiber 76 where it is transferred to the detection optics, including a third lens 77 and photodiode 78. This allows one to have the source and detector located at some distance from the sample, which can be advantageous if the source or detector are bulky compared to the sample (e.g. as in the case of an optical spectrum analyzer to examine the optical spectrum of the emission light). It can also serve to protect the source and detector optics from the heat generated by the block holding the sample 74. Optional bandpass filters 79 are included to better isolate the emission spectra from the excitation spectra.

While the embodiment shown utilizes two different fibers, one can also use a single fiber at the sample, by making use of either a fused splitter or wave division demultiplexor to combine and split the light through a common fiber, or by making use of a suitable arrangement of lenses and free space dichroic or partial mirror to transfer light to and from said common fiber.

As a further variation, instead of optical fibers, one can make use of rigid light pipes to transfer light to and from the sample in the same way as optical fibers. These light pipes can be molded in a specific defined shape to transfer the light in a manner to optimize use of space in the instrument. In all cases, by taking the geometry of the sample vial in mind during the optical design phase, the overall sensitivity of the apparatus can be optimized.

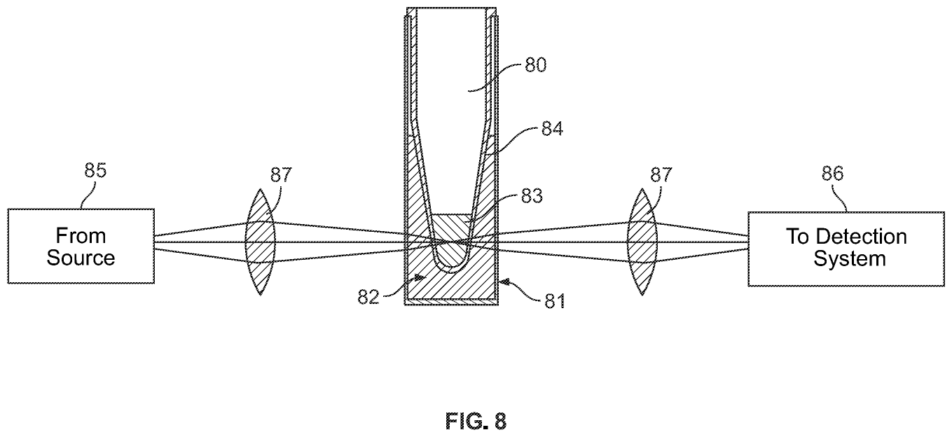

FIG. 8 shows a further example embodiment in which the refraction and scattering effects from the vial shape are counteracted by immersing the vial 80 inside a chamber 81 with transparent walls and containing a fluid 82 whose refractive index matches the contents of the sample vial 80. The index matching could be distilled water, mineral oil, or other commercially available fluid. By doing this, the refractive effects of the vial 80 and sample contents 83 are negated. Light can enter and exit through optically flat surfaces. Refraction effects can be limited to those occurring between the index matching fluid 82 and the vial wall 84 and between the vial wall 84 and sample contents 83. Since the inner and outer wall surfaces are essentially parallel to one another, refraction at these surfaces largely cancel one another out. As an additional feature, one can heat the chamber 81 containing the index matching fluid 82, making the fluid into a thermal bath. Because the index matching fluid 82 is in intimate thermal contact with the vial 80, the vial 80 can be heated to a desired temperature more efficiently.

As a further variation, one is also not limited to using a chamber with optical flat walls. A chamber can be devised with walls designed to further focus and direct the light. For instance, the chamber could be formed in the shape of a sphere with an opening at the top for the vial to enter. The sample fluid can be located at the center of the sphere, allowing the sphere to concentrate light from the source 85 onto the sample 83 and then concentrate light from the vial 80 onto the photodiode in the detection system 86. Correctly designed, the chamber can be adapted to contain one vial or a line of vials, again allowing scaling of the instrument for mass sampling. Lenses 87 can be used to focus the light from the source 85 and to focus the light going to the detection system 86.

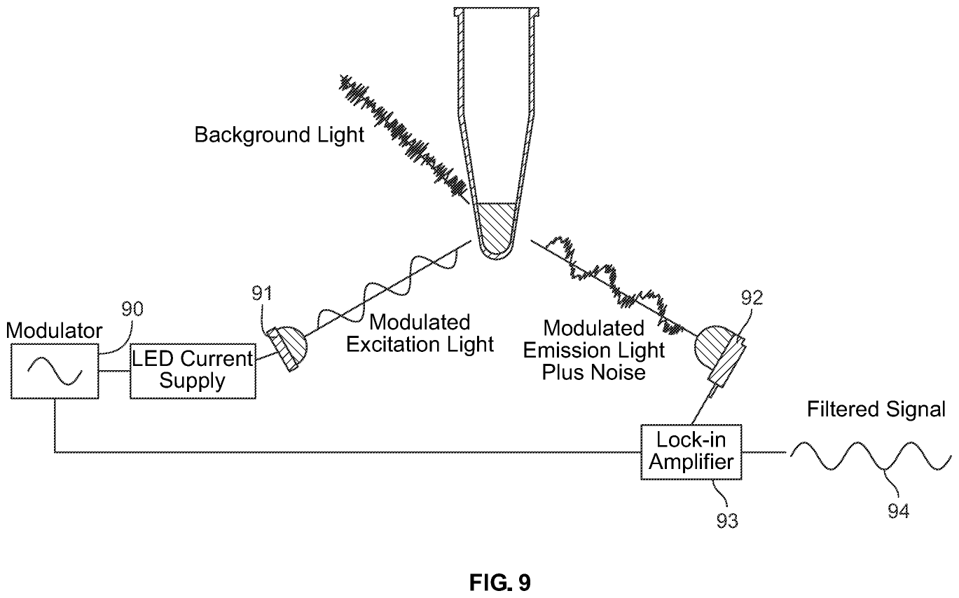

While designing the optical and physical layout of the apparatus, one needs to be cognizant of the surrounding ambient light conditions. Stray light from the environment can be erroneously picked up by the collection optics, thereby generating false positive signals or reducing the overall sensitivity of the instrument. Care should therefore be taken by the user to design the apparatus with sufficient shielding, both surrounding the instrument and via baffles and apertures in the optical path, to block as much stray light as possible while maximizing signal sensitivity. An alternative option shown in FIG. 9 is to modulate the source light 91 with a modulator 90 at a well defined frequency, preferably a frequency significantly different than multiples and factors of 60 Hz and 50 Hz, which are common electrical frequencies used in the electrical supplies in North American and Europe/Asia respectively. The electrical signal from the photodiode 92 can be analyzed through either circuitry (e.g. a lock-in amplifier 93) or software designed to discriminate signals 94 matching the modulation frequency. In this way one can further improve the signal to noise ratio of the apparatus.

The example embodiments discussed herein can include lenses to focus the light from the source to the center of the sample and to focus the light going to the detection system from the center of the sample.

The scope of the claims should not be limited by the preferred embodiments set forth in the examples but should be given the broadest interpretation consistent with the description as a whole. For example, the light source and detector can be any suitable source and detection available. As a further example, the location of the focusing elements, filters and optical elements relative to the light source and detector can be varied amongst each other. For example, the optical filters can be placed before or after the focusing elements. As a further variant, the intensity of the excitation light from the source can be controlled either electrically or optically in order maximize the strength of the fluorescence from the sample without incurring secondary effects such as bleaching of the fluorescence dyes or heating of the sample via absorption of the light. As yet a further variation, the intensity of the excitation light from the source can be modulated either electrically or optically, coupled with a frequency sensitive detection system tuned to the same frequency as the source, to further isolate unwanted optical signals, either from surrounding ambient light or emission light from adjacent samples in an array. The amounts, sizes and examples discussed herein are for example purposes only and should not limit the scope of the claims or variants thereof which would be understood by a person of skill in the art.

1. A fluorescence detecting apparatus comprising:
a sample container for holding a sample;
a block for holding the sample container and varying a temperature of the sample;
a light source directed to the sample;
a detector to detect and measure fluorescent light emitted by the sample; and
optical elements which are configured to account for the focusing and refraction effects of the sample container and sample on the fluorescent light.

2. The fluorescence detecting apparatus of claim 1 wherein the optical elements are configured to focus light from the light source onto the center of said sample and from the center of the sample onto the detector through the sample container.

3. The fluorescence detecting apparatus as set forth in claim 1 further comprising a first optical filter placed in an optical path of excitation light from the light source and a second optical filter placed in an optical path of emission light from the sample.

4. The fluorescence detecting apparatus as set forth in claim 1 further comprising one or more optical fibers between the light source and detector and the sample container, wherein the one or more optical fibers transfer excitation light between the light source and one of the optical elements and transfer emission light between the detector and one of the optical elements.

5. A fluorescence detecting system comprising an array of fluorescence detecting apparatus as set forth in claim 1, arranged to detect and measure fluorescence from multiple samples simultaneously.

6. The fluorescence detecting apparatus as set forth in claim 1 wherein the optical elements include a dichroic mirror or a partial reflecting mirror.

7. The fluorescence detecting apparatus as set forth in claim 6 wherein the dichroic mirror or the partial reflecting mirror combines and differentiates excitation light from the light source and the fluorescent light.

8. The fluorescence detecting apparatus as set forth in claim 7 further comprising a first optical filter placed in an optical path of said excitation light prior to the dichroic mirror and a second optical filter placed in an optical path of said fluorescence light after returning via the mirror.

9. A fluorescence detecting apparatus as set forth in claim 8 further comprising one or more focusing optical elements; and one or more optical fibers to transfer light from said light source to the dichroic mirror and/or between said dichroic mirror and one of the focusing optical elements onto the sample, and/or from said dichroic mirror to the detector.

10. A fluorescence detecting system comprising an array of fluorescence detecting apparatus as set forth in claim 6, arranged to detect and measure fluorescence from multiple samples simultaneously.

11. The fluorescence detecting apparatus of claim 1 wherein the block is an external container that has transparent walls and contains an index matching fluid.

12. A fluorescence detecting apparatus comprising:
a sample container for holding a sample;
a container holder for holding the sample container and varying a temperature of the sample, said container holder having transparent walls and containing an index matching fluid;
a light source directed to the sample;
a detector to detect and measure fluorescent light emitted by the sample;
wherein said container holder and index matching fluid are configured to account for and counteract the focusing and refraction effects of the sample container and sample.

13. The fluorescence detecting apparatus of claim 12 further comprising optical elements that are configured to focus excitation light from the light source onto the center of said sample and emission light from the center of the sample onto the detector.

14. The fluorescence detecting apparatus of claim 13 wherein the optical elements are configured to focus the excitation light and the emission light from different directions.

15. The fluorescence detecting apparatus as per claim 12 further comprising optical filters that are placed in an optical path of excitation light from said light source and an optical path of said fluorescent light.

16. The fluorescence detecting apparatus as per claim 15 further comprising optical elements that are configured to focus light from the light source onto the center of said sample and from the center of the sample onto the detector, and wherein the optical filters are placed either before or after the optical elements.

17. The fluorescence detecting apparatus as per claim 12 further comprising one or more focusing optical elements; and one or more optical fibers connected to said light source and/or said detector to transfer excitation light from the light source and/or the fluorescence light between the light source and/or the detector to one of the focusing optical elements.

18. A fluorescence detecting system comprising an array of fluorescence detecting apparatus as set forth in claim 12, arranged to detect and measure fluorescence from multiple samples simultaneously.

19. The fluorescence detecting apparatus as per claim 1 further comprising a controller for controlling intensity of excitation light from the light source, either electrically or optically, to maximize the fluorescence light from the sample without incurring secondary effects.

20. The fluorescence detecting apparatus as per claim 1 further comprising a modulator for modulating intensity of excitation light from the light source, either electrically or optically, to further isolate unwanted optical signals, wherein the detector is tuned to the same frequency as the light source.
